(19) United States
(12) Patent Application Publication
(10) Pub. No.: US 2008/0032741 A1
(43) Pub. Date: Feb. 7, 2008

(54) Programmable Functionalities for Mobile Consumer Communications Devices with Identification-Modules

(75) Inventor: John Tumminaro, Palo Alto, CA (US)

Correspondence Address: JAMES E. EAKIN, P.O. BOX 1250, MENLO PARK, CA, 94025-4317, US

(73) Assignee: OBOPAY, Redwood City, CA (US)

(21) Appl. No.: 11/694,906

(22) Filed: Mar. 30, 2007

Related U.S. Application Data
(60) Provisional application No. 60/744,013, filed on Mar. 30, 2006.
(60) Provisional application No. 60/744,930, filed on Apr. 15, 2006.

(51) Int. Cl. H04M 1/00

(52) U.S. Cl. 455/558

(57) ABSTRACT

Many mobile consumer communications devices, such as cellular telephones, PDAs, laptop computers and the like, require an identification module to engage a wireless communications network. An arrangement with an identification module adaptor connected to a housing holding an identification module and a programmable processing unit adds functionality to the mobile consumer communications device. The programmable processing unit which is electrically interposed between the adaptor and said Identification Module is adapted to pass all data communications between the mobile consumer communications device (through the adaptor) and the Identification Module unimpeded for conventional wireless communications in one case, and to intercept the data communications with program applications running on the programmable processing.

### CROSS-REFERENCE TO RELATED APPLICATIONS

This patent application claims priority to U.S. Provisional Patent Application Nos. 60/744,013, filed Mar. 30, 2006 and 60/744,930, filed Apr. 15, 2006, which are incorporated by reference along with all other references cited in this application.

### BACKGROUND OF THE INVENTION

This invention is related to mobile communications devices for consumers and, more particularly, to the ways of increasing the functionality of cellular telephones and other mobile consumer communications devices with removable identification modules.

Most mobile consumer communications devices, e.g., cellular telephones, PDAs (Personal Digital Assistants), laptop computers, and the like, contain a removable identification module (IM) card or chip which uniquely identifies a specific consumer's account to a wireless communications network carrier. The IM card/chip stores data and provides some of the “brains” which allows the host mobile consumer communications device to function, e.g., to make and receive voice calls, to send or receive messages, to run computer applications, and so forth. This allows a user, for instance, to easily change cellular telephones by removing his or her IM card/chip from one telephone and reinserting the card/chip into another telephone. The need to activate the second cellular telephone by the communications network is eliminated.

Different types of mobile consumer communications devices use different types of IM cards/chips. For example, a SIM (Subscriber Identity Module) card works with GSM (Global System for Mobile communications) devices. Another type of IM card/chip is a USIM (Universal Subscriber Identity Module) which operates with the UMTS (Universal Mobile Telecommunications System) devices and still another is the RUIM (Removable User Identity Module) for CDMA (Code Division Multiple Access) devices. For purposes of this patent application, any IM card/chip is termed simply an IM or identification module.

But regardless of the type, the IMs and their host mobile communications devices are generally “closed” systems, proprietary to the wireless communications network carriers (e.g., Cingular, T-Mobile, Verizon, etc.), the manufacturer of the mobile consumer communications device, and the IM manufacturers (e.g., Gemplus, Oerthur, etc.). Nonetheless, the communications protocols, and the interface between the IM host communications devices, i.e., the mobile consumer communications device, and the IMs are open by the engineering standards set by the ISO (International Standards Organization).

The present invention takes advantage of these open standards to create additional functionalities for the host mobile consumer communications device without interfering with the IM operations. The mobile consumer communications device still operates with the IM, but additional functionality is “inserted” into the device. The present invention allows the restrictions of the mobile carriers, handset manufacturers and IM manufacturers to be bypassed so that mobile program applications can run in the mobile consumer communications device for enhanced functionality of the device.

### BRIEF DESCRIPTION OF THE DRAWINGS

FIG. 1 is a representation of a typical mobile consumer communications device, a cellular telephone, which operates with an identification module.

FIG. 2 is a block diagram of an arrangement of an IM adaptor connected to an IM and a programmable processing unit, in accordance with one embodiment of the present invention

FIG. 3A illustrates how the IM adaptor of the FIG. 2 arrangement may be plugged into the IM socket of a cellular telephone; FIG. 3B illustrate how the FIG. 2 arrangement is flipped over so that it can be stored within the cellular telephone.

FIG. 4 is a block diagram illustrating the electrical connections of the FIG. 2 arrangement according to an embodiment of the present invention.

FIG. 5 is a block diagram of the FIG. 2 arrangement with a USB connection for laptop computers to communicate with a wireless communications network with the advantages of the present invention.

FIG. 6 is a representation of some of the software elements in the programmable processing unit in the FIG. 2 arrangement in accordance with an embodiment of the present invention.

### DETAILED DESCRIPTION OF THE INVENTION

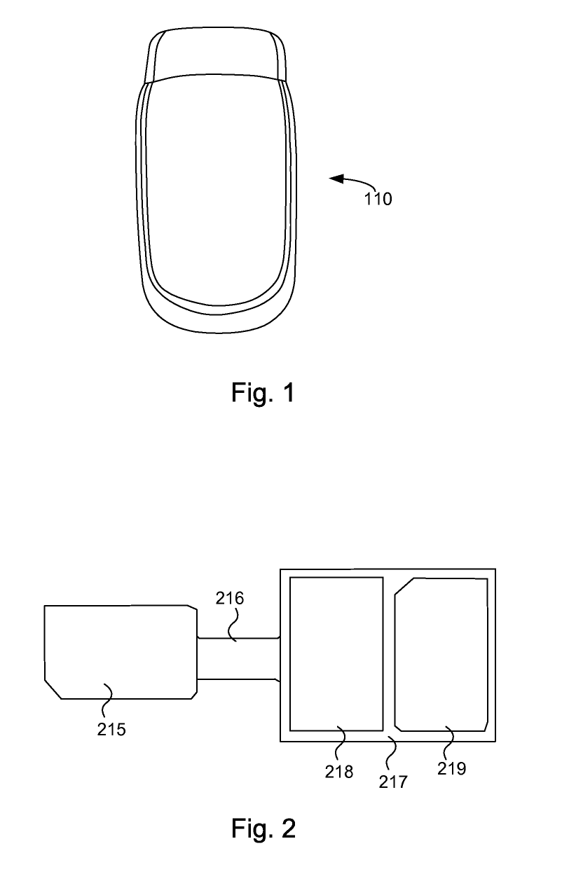

FIG. 1 illustrates an example mobile consumer communications device, a typical cellular telephone 110 in this case, which can benefit from the present invention. Inside the cellular telephone is an IM (identification module) which fits into an IM socket. As stated earlier, the IM contains the user's identification information for the access to the communications network and with the IM inserted into the IM socket, the device 110 can operate with the wireless communications network in a conventional fashion.

FIG. 2 illustrates one embodiment of the present invention. An IM 219, whether in the form of a card or chip, is mounted in a thin housing 217 which also holds a programmable processing unit 218. The housing 217 interconnects the IM 219 and the programmable processing unit 218, and by a thin ribbon cable 216, the housing 217 is connected to an IM adaptor 215.

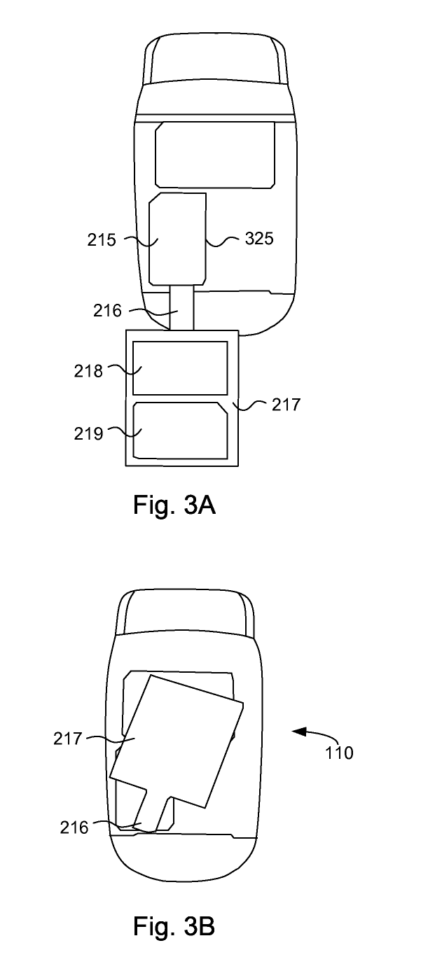

The IM adaptor 215 can fit into the IM socket of the mobile consumer communications device 110, as illustrated in FIG. 3A. The IM adaptor 215 fits into the IM socket 225 of the cellular telephone 110 which has its back cover (not shown) removed. As shown, the IM adaptor 215 fits into the IM socket 225 and connects the IM 219 through the ribbon cable 216 and the programmable processing unit 219. Since the cable 216 is flexible, the housing 217 can be flipped over into the cellular telephone 110, as shown in FIG. 3B. In practice, a battery (not shown) for the cellular telephone 10 may be installed over the IM socket 225 and IM adaptor 215 and then the housing 217 flipped over the battery, before the cover can be replaced as shown in FIG. 1.

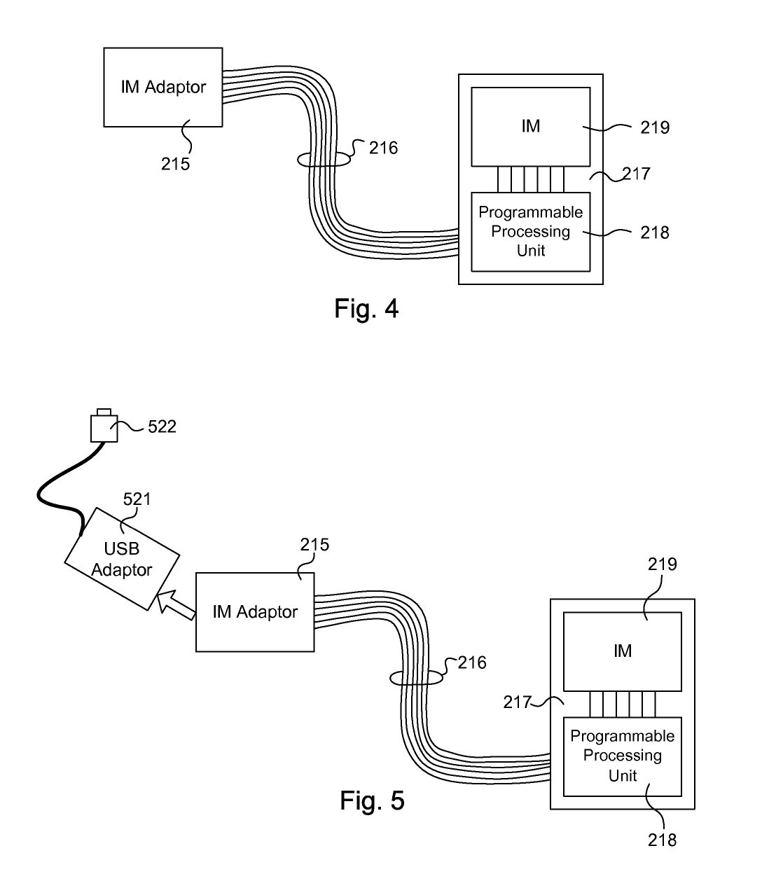

FIG. 4 illustrates the electrical connections between the IM adaptor 215, the ribbon cable 16, the programmable processing unit 218 and the IM 219. All electronic traffic (i.e. data communications) between the IM socket 225 in the mobile consumer communications device 10 and the IM 19 must pass through the programmable processing unit 18. As explained below, the programmable processing unit 218 operates as a gate to allow the electronic traffic to pass-through unimpeded for conventional, or native, wireless communications in one case. In another case the electronic traffic can be intercepted and enhanced by program applications running in the programmable processing unit 18 to provide enhanced functionality to the user of the device 110.

The programmable processing unit 218 can be implemented in a microcontroller, an ASIC (Application Specific Integrated Circuit), a so-called SOC (System-On-a-Chip) and other integrated circuits. Each of these types of integrated circuits has one or more processor units and memory of varying capacity and offers differing degrees of customization, capability and costs for the particular requirements of the program applications. The memory of the programmable processing unit 218 holds the program applications for enhanced functionalities and the processor units execute the program applications. The program applications are uploaded through the wireless communications network.

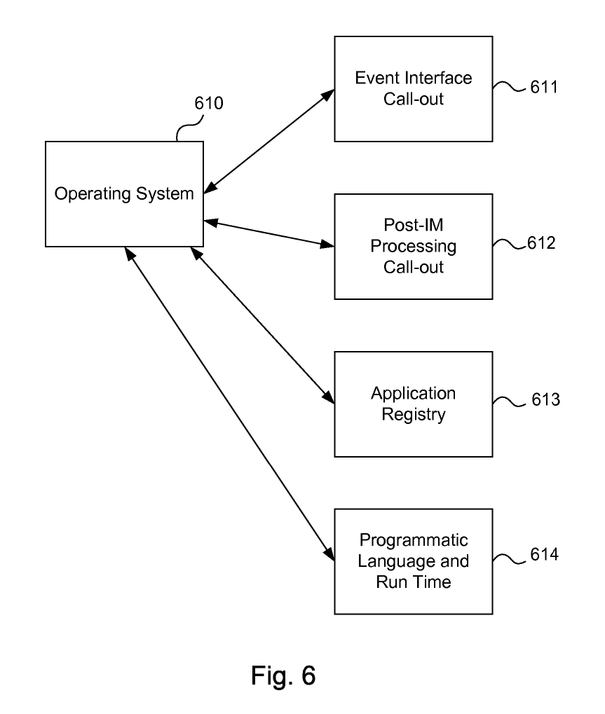

In any case, the programmable processing unit 218 operates with an operating system 610, event interface call-outs 611, post-IM processing call-outs 612, an application registry 613, and a programmatic language and runtime 614, as illustrated in FIG. 6. The operating system facilitates the pass-through communications between the host mobile consumer communications device 110 and the IM 219, as explained previously. The operating system also provides programmatic call-outs to the program applications which are registered and installed in the programmable processing unit 218.

The event interface call-outs 611 provide a programmatic event interface which a program application implements in order to gain programmatic control of the host mobile consumer communications device upon specific mobile device events, e.g., a press of a button, a ring signal, etc. During this control, the program application has the ability to add functionality and processing to the event.

The post-IM processing call-outs 612 provide a programmatic event interface which a program application implements in order to gain programmatic control of the host mobile consumer communications device upon a return from the native IM processing of the mobile consumer communications device event. The IM is always included last in the processing chain of an event. During this control, the program application has the ability to add functionality and post processing to the event before the mobile consumer communications device regains control.

The application registry 613 provides a configuration so that program applications can be registered as interested in specific events (and therefore be programmatically called when those events occur). Several program applications may be registered for the same event and are called in a chain.

The programmatic language and runtime 614 provides a programmatic language and platforms upon which the applications are created. Several suitable languages/runtimes which are standard include BREW (Binary Runtime Environment for Wireless) developed by Qualcomm, Inc. of San Diego, Calif. to provide a standard set of application-programming interfaces for developers to easily add new features and applications to Qualcomm-based wireless hardware, i.e., handsets equipped with CDMA chipsets; J2ME (Java 2 Mobile Edition), a Java-based technology for mobile systems from Sun Microsystems, Inc. of Santa Clara, Calif.; .NET from Microsoft, Inc. of Redmond, Wash. to provide a software development platform for the Windows operating system and uses XML (eXtended Markup Language); and Symbian, a platform designed for mobile devices by a joint venture of many companies, including L.M. Ericsson of Stockholm, Sweden, and Nokia Corp. of Espoo, Finland. Of course the preceding language/platforms represent only examples and other languages could be used.

U.S. patent application Ser. No. 11/694,747 filed Mar. 30, 2007 is incorporated by reference and discusses a mobile person-to-person payment system. Some examples of program applications which may be run in the programmable processing unit 218 are described in an accompanying patent application, U.S. patent Ser. No. ______, entitled, “Data Communications Over Voice Channel With Mobile Consumer Communications Devices,” filed on even date by the present inventor and incorporated herein by reference for all purposes. That patent application describes a way of sending data over the voice channel, rather the data channel, of the wireless communications network of a mobile consumer communications device. In one program application, the mobile consumer communications device can send text messages to another mobile consumer communications device over its voice channel. In another patent application mobile payments may be performed by the mobile consumer communications device over its voice channel.

Thus far the mobile consumer communications device, such as the cellular telephone 110 of FIG. 1, has been described as requiring only an IM which fits into the device's IM socket to engage a wireless communications network. On the other hand, laptop computers typically do not have a built-in IM socket. Laptop computers use a USB adaptor 521 which accepts the user's IM and the USB adaptor 521 is connected to a USB connector 522 which fits into the laptop computer's USB port. FIG. 5 shows how the previously described IM adaptor 215 fits into the USB adaptor 521 to place the IM 219 in contact with the host laptop computer. With the IM 219 in contact with the laptop computer to engage the wireless communications network, the programmable processing unit 218 allows additional functionality through program applications.

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

The invention claimed is:

1. For a mobile consumer communications device having an Identification Module socket to receive an Identification Module to operate with a wireless communications network, an apparatus comprising:
an adaptor for connecting to said mobile consumer communications device Identification Module socket;
a housing connected to said adaptor and further comprising:
an Identification Module; and
a programmable processing unit electrically interposed between said adaptor and said Identification Module and adapted to pass all data communications between said mobile consumer communications device and said Identification Module unimpeded for conventional wireless communications in one case, and to intercept said data communications with program applications running on said programmable processing unit to provide enhanced functionality to said mobile consumer communications device.
